(19) United States
(12) Patent Application Publication
(10) Pub. No.: US 2017/0100614 A1
(43) Pub. Date: Apr. 13, 2017

(54) Remotely Deployable Fire Protection Device

(71) Applicant: Michael Ingersoll, Arvada, CO (US)

(72) Inventor: Michael Ingersoll, Arvada, CO (US)

(21) Appl. No.: 14/881,303

(22) Filed: Oct. 13, 2015

(51) Int. Cl. A62C 2/06; A62C 3/02

(52) U.S. Cl. CPC A62C 2/06; A62C 3/0214

(57) ABSTRACT

A remotely deployable fire protection device for remotely deploying a fire resistant panel between a structure and a fire includes a housing that is fire resistant. Each of opposing ends of a shaft is rotationally coupled to a respective one of opposite ends of the housing. A panel that is flexible and fire resistant has a top edge coupled to the shaft. A base is coupled to a bottom edge of the panel. A lock, operationally coupled to the shaft, is positioned in the housing proximate to a respective one of the opposite ends. An actuator, coupled to the housing proximate to the lock and operationally coupled to the lock, comprises a communicator for remote deployment of the panel. A plurality of mounting brackets is coupled to the housing. A cable with a first terminus coupled to the actuator is available for manual deployment of the panel.

### BACKGROUND OF THE DISCLOSURE

### Field of the Disclosure

The disclosure relates to fire protection devices and more particularly pertains to a new fire protection device for remotely deploying a fire resistant panel between a structure and a fire.

### SUMMARY OF THE DISCLOSURE

An embodiment of the disclosure meets the needs presented above by generally comprising a housing that is fire resistant. Each of opposing ends of a shaft is rotationally coupled to a respective one of opposite ends of the housing. A panel that is flexible and fire resistant has a top edge coupled to the shaft. A base is coupled to a bottom edge of the panel. A lock, operationally coupled to the shaft, is positioned in the housing proximate to a respective one of the opposite ends. An actuator, coupled to the housing proximate to the lock and operationally coupled to the lock, comprises a communicator for remote deployment of the panel. A plurality of mounting brackets is coupled to the housing. A cable with a first terminus coupled to the actuator is available for manual deployment of the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a remotely deployable fire protection device according to an embodiment of the disclosure.

FIG. 2 is a front view of an embodiment of the disclosure.

FIG. 3 is a front view of an embodiment of the disclosure.

FIG. 4 is a detail view of an embodiment of the disclosure.

FIG. 5 is a side cut-away view of an embodiment of the disclosure.

### DESCRIPTION OF THE PREFERRED EMBODIMENT

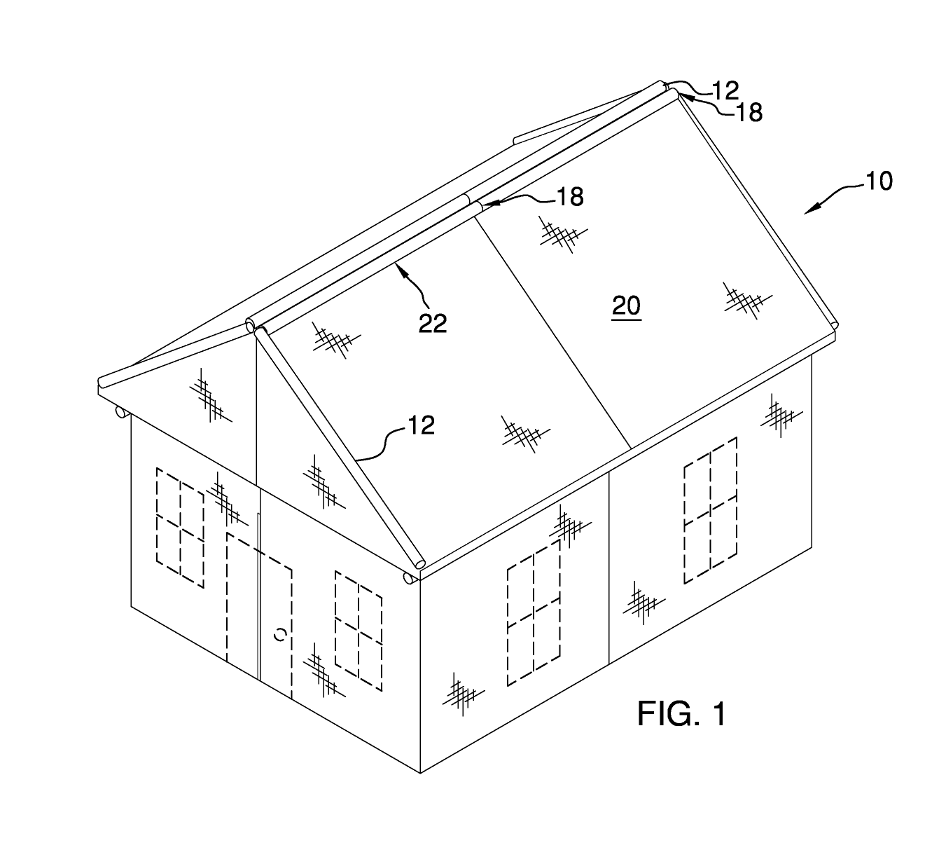

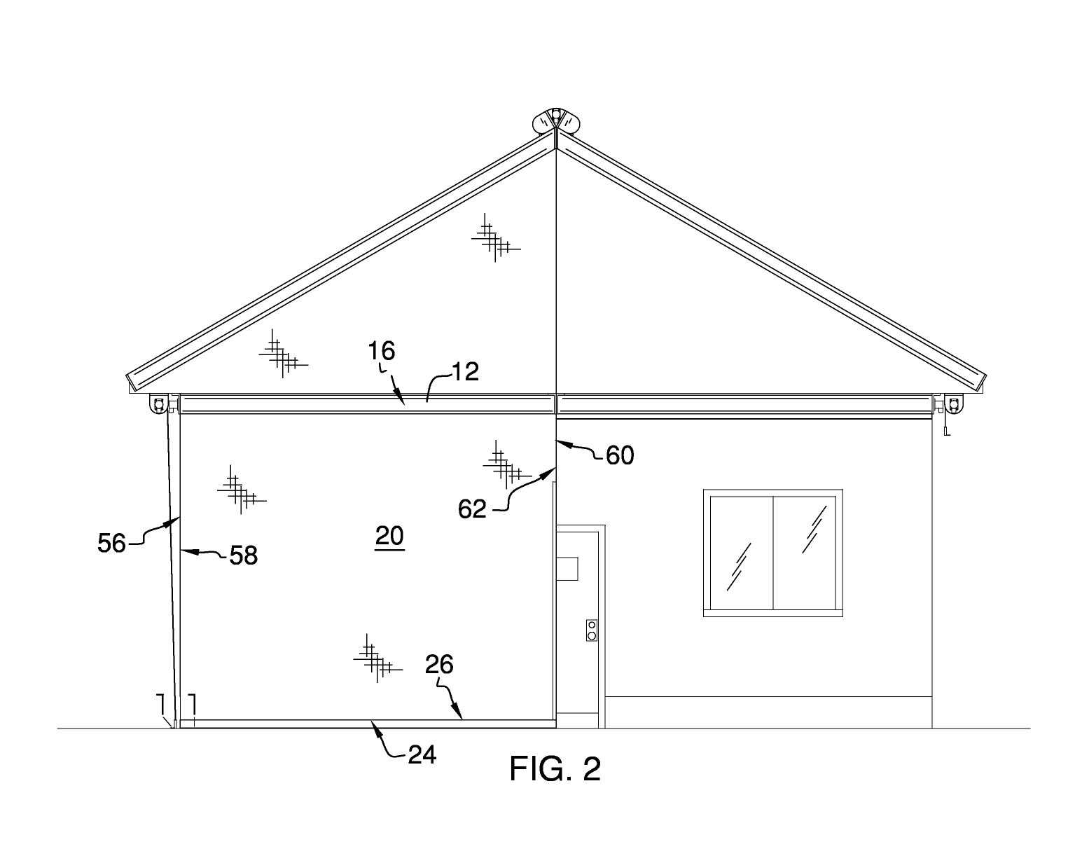

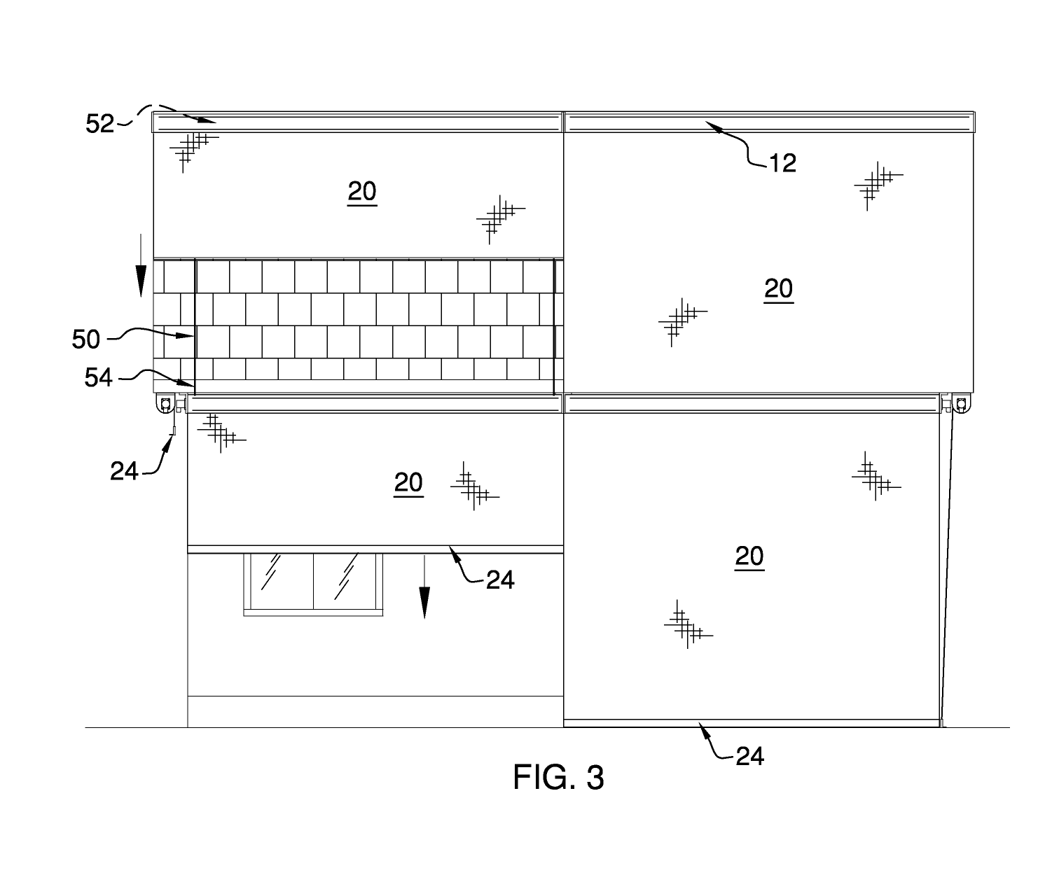

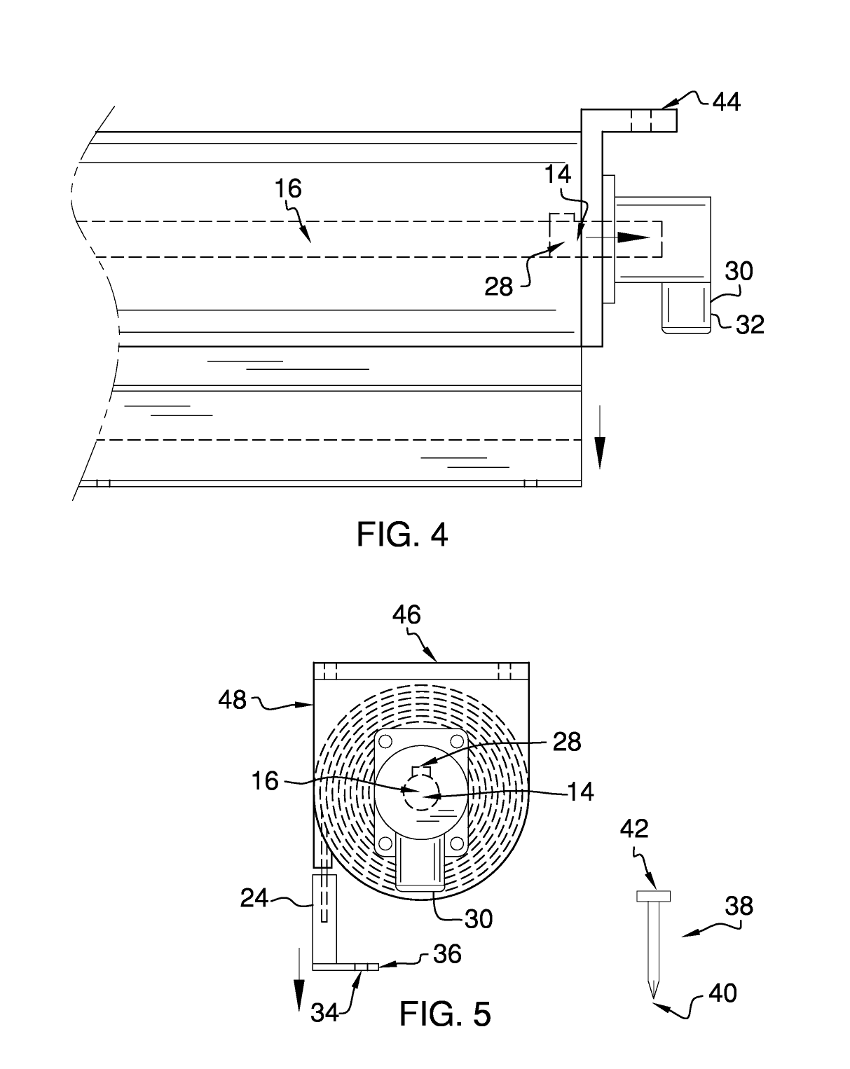

With reference now to the drawings, and in particular to FIGS. 1 through 5 thereof, a new fire protection device embodying the principles and concepts of an embodiment of the disclosure and generally designated by the reference numeral 10 will be described.

As best illustrated in FIGS. 1 through 5, the remotely deployable fire protection device 10 generally comprises a housing 12 that is fire resistant. Each of opposing ends 14 of a shaft 16 is rotationally coupled to a respective one of opposite ends 18 of the housing 12. A panel 20 that is flexible and fire resistant has a top edge 22 coupled to the shaft 16. A base 24 is coupled to a bottom edge 26 of the panel 20. The base 24 is of sufficient mass to induce the panel 20 from a rolled and stowed position around the shaft 16 to a deployed position, such that the panel 20 covers a portion of a structure. A lock 28 is positioned in the housing 12 proximate to a respective one of the opposite ends 18. The lock 28 is operationally coupled to the shaft 16, such that the lock 28 is capable of preventing rotation of the shaft 16. An actuator 30 is coupled to the housing 12 proximate to the lock 28. The actuator 30 is operationally coupled to the lock 28. The actuator 30 comprises a communicator 32, such that the communicator 32 is capable of receiving a deployment signal and inducing the actuator 30 to disengage the lock 28, thereby deploying the panel 20.

A plurality of holes 34 is positioned in the base 24. Preferably, the plurality of holes 34 is positioned in a protruding lower edge 36 of the base 24. The device 10 also comprises a plurality of stakes 38 that is fire resistant and is complimentary to the holes 34. The stakes 38 each have a pointed end 40 and a stop end 42 that is larger than a respective one of the plurality of holes 34. The pointed ends 40 can be inserted through the holes 34 and the stakes 38 driven into the ground with the stop ends 42 engaging the base 24 to secure the panel 20 between the structure and a fire.

A plurality of mounting brackets 44 is coupled to the housing 12 to be used to secure the housing 12 to the structure. The brackets 44 are positioned proximate to the opposite ends 18 of the housing 12. The brackets 44 may be coupled to a top 46 of the housing 12. The brackets 44 also may be coupled to a back 48 of the housing 12. Preferably, the brackets 44 are selectively couplable to the top 46 and the back 48 of the housing 12.

A cable 50 that has a first terminus 52 coupled to the actuator 30 also has a second terminus 54 accessible to the user to pull to manually disengage the lock 28 to deploy the panel 20. A first fastener 56 is coupled to a left edge 58 of the panel 20 and a second fastener 60 is coupled to a right edge 62 of the panel 20. The second fastener 60 is complimentary to the first fastener 56. The first fastener 56 and the second fastener 60 are selected from the group consisting of Velcro type hook and Velcro type loop fasteners.

In use, a number of devices 10 sufficient to protect the exterior of a structure would be installed using the brackets 44. The communicator 32 is capable of receiving a deployment signal and inducing the actuator 30 to disengage the lock 28, such that the base 24 induces the panel 20 from a rolled and stowed position around the shaft 16 to a deployed position. The pointed ends 40 of the stakes 38 can be inserted through the holes 34 and the stakes 38 driven into the ground with the stop ends 42 engaging the base 24 to further secure the panel 20 between the structure and a fire. A device 10 can have its panel 20 secured an adjacent panels 20 of additional devices 10 by connecting the first fastener 56 positioned on the left edge 58 and the second fastener 60 on the right edge 62 to a respective first fastener 56 and respective second fastener 60 on adjacent devices 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A remotely deployable fire protection device comprising:
a housing, said housing being fire resistant;
a shaft, said shaft having opposing ends, each of said opposing ends being rotationally coupled to a respective one of opposite ends of said housing;
a panel, said panel being flexible and fire resistant, said panel having a top edge, said top edge being coupled to said shaft;
a base, said base being coupled to a bottom edge of said panel;
a lock, said lock being positioned in said housing proximate to a respective one of said opposite ends, said lock being operationally coupled to said shaft such that said lock extends into said shaft whereby said lock obstructs rotation of said shaft;
an actuator, said actuator being coupled to said housing proximate to said lock, said actuator being operationally coupled to said lock such that activation of said actuator removes said lock from said shaft whereby said shaft is permitted to rotate freely, said actuator comprising a communicator wherein said actuator disengages said lock upon receiving a deployment signal through said communicator;
a plurality of mounting brackets, said brackets being coupled to said housing; and
a cable, said cable having a first terminus coupled to said actuator

2. The device of claim 1, further comprising:
a first fastener, said first fastener being coupled to a left edge of said panel;
a second fastener, said second fastener being coupled to a right edge of said panel; and
said second fastener being complimentary to said first fastener.

3. The device of claim 2, further including said first fastener and said second fastener being hook and loop fasteners.

4. The device of claim 1, further comprising:
a plurality of holes, said plurality of holes being positioned in said base;
a plurality of stakes, said stakes being fire resistant, said stakes being complimentary to said holes, said stakes having a pointed end and a stop end, each said stop end being larger than a respective one of said plurality of holes; and
wherein said pointed end can be inserted through said hole and said stake driven into the ground with said stop end engaging said base to secure said panel between the structure and a fire.

5. The device of claim 4, further including said plurality of holes being positioned in a protruding lower edge of said base.

6. The device of claim 1, further including said brackets being positioned proximate to said opposite ends of said housing.

7. The device of claim 1, further including said brackets being coupled to a top of said housing.

8. The device of claim 1, further including said brackets being coupled to a back of said housing.

9. The device of claim 1, further including said brackets being selectively couplable to said top and said back of said housing.

10. A remotely deployable fire protection device comprising:
a housing, said housing being fire resistant;
a shaft, said shaft having opposing ends, each of said opposing ends being rotationally coupled to a respective one of opposite ends of said housing;
a panel, said panel being flexible and fire resistant, said panel having a top edge, said top edge being coupled to said shaft;
a base, said base being coupled to a bottom edge of said panel, wherein said base is of sufficient mass to induce said panel from a rolled and stowed position around said shaft to a deployed position, such that said panel covers a portion of a structure;
a lock, said lock being positioned in said housing proximate to a respective one of said opposite ends, said lock being operationally coupled to said shaft such that said lock extends into said shaft whereby said lock obstructs rotation of said shaft;
an actuator, said actuator being coupled to said housing proximate to said lock, said actuator being operationally coupled to said lock such that activation of said actuator removes said lock from said shaft whereby said shaft is permitted to rotate freely, said actuator comprising a communicator wherein said actuator disengages said lock upon receiving a deployment signal through said communicator, wherein said communicator is capable of receiving a deployment signal and inducing said actuator to disengage said lock, such that said panel is deployed;
a plurality of holes, said plurality of holes being positioned in said base, said plurality of holes being positioned in a protruding lower edge of said base;
a plurality of stakes, said stakes being fire resistant, said stakes being complimentary to said holes, said stakes having a pointed end and a stop end, each said stop end being larger than a respective one of said plurality of holes, wherein said pointed end can be inserted through said hole and said stake driven into the ground with said stop end engaging said base to secure said panel between the structure and a fire;
a plurality of mounting brackets, said brackets being coupled to said housing, wherein said brackets are positioned to secure said housing to the structure, said brackets being positioned proximate to said opposite ends of said housing, said brackets being coupled to a top of said housing, said brackets being coupled to a back of said housing, said brackets being selectively couplable to said top and said back of said housing;
a cable, said cable having a first terminus coupled to said actuator, wherein a second terminus of said cable is accessible to the user to pull to manually disengage said lock for deployment of said panel;
a first fastener, said first fastener being coupled to a left edge of said panel;
a second fastener, said second fastener being coupled to a right edge of said panel, said second fastener being complimentary to said first fastener;
said first fastener and said second fastener being selected from the group consisting of hook and loop fasteners; and
wherein said communicator is capable of receiving a deployment signal and inducing said actuator to disengage said lock, wherein said base induces said panel from a rolled and stowed position around said shaft to a deployed position, and such that said pointed ends of said stakes can be inserted through said holes and said stakes driven into the ground with said stop ends engaging said base to secure said panel between the structure and a fire.
